(19) United States
(12) Patent Application Publication
(10) Pub. No.: US 2003/0031235 A1
(43) Pub. Date: Feb. 13, 2003

(54) PCMCIA CDMA data modem with test code selection switch

(75) Inventors: Young Keun Kim, San Diego, CA (US); Seung Beom Kim, San Diego, CA (US); Myung Ho Ahn, Poway, CA (US); Yeon Tak Jung, San Diego, CA (US); Kyung-Ha Jung, San Diego, CA (US)

Correspondence Address: Jonathan Y. Kang, Esq., Lee & Hong P.C., 11th Floor, 221 N. Figueroa Street, Los Angeles, CA, 90012-2601, US

(73) Assignee: CYBERLANE INC.

(21) Appl. No.: 09/908,910

(22) Filed: Jul. 18, 2001

(51) Int. Cl. H04K 1/00

(52) U.S. Cl. 375/147

(57) ABSTRACT

A mobile telecommunication apparatus, such as a CDMA modem for use with a host computer comprises a microprocessor, an interface device communicating with the microprocessor to interface with the host computer, a memory connected to the microprocessor having a ROM area and a RAM area, the ROM area storing a modem protocol code for operation of the modem and a testing code for testing the modem, an antenna, a RF/IF device connected to the antenna and communicating with the microprocessor, and a code selection switch connected to the microprocessor to select one of a normal mode and a service mode. Upon selection of the normal mode, the modem protocol code is executed, and upon selection of the service mode, the testing code is executed.

### BACKGROUND OF THE INVENTION

b 1. Field of the Invention

This invention relates to a PCMCIA CDMA data modem, and more particularly, to a modem having a code selection switch and support program to provide easy testing of the modem.

2. Description of the Related Art

FIG. 1 shows a time line of the CDMA product development and manufacturing process, such as a cellular phone, and field service and maintenance processes. The first part of the development process is a prototype production 300, to develop a prototype and a working sample. The prototype is a first sample product made based on a basic design and the working sample is a product made based on any design changes and adjustments to the prototype. Next follows the conclusion of the verification of hardware design, RF performance improvement, PCB artwork and layout. This is the pre-stage of a final design to the production line.

A prototype is then subjected to a preproduction process 305. A working sample is made through a production line that applies to an actual mass production line at this stage. Many working prototype-productions are produced, and products from the pre-production process are produced in the hundreds. The performance and the quality of the product are checked. Any problems at this point are adjusted before reproducing the product. Generally, a CDMA product requires FCC approval or a CDC test at this point.

The product design that passed the pre-production stage now moves to the mass production process 310, the third stage of the process. The parts can be substituted to lower the production cost without changing the design and performance of the product. The hardware and software can be adjusted according to the alternate parts available at this point.

The products from mass production are finally delivered to the service provider or vendor and over to the end user. The problems during usage of the product can be resolved at the service centers operated by the service provider or vender and by the manufacturer if a service center cannot resolve a problem. Generally, the manufacturer delivers the hardware circuit diagram and software tools to the service center or the vendor in order to provide efficient service, so most of the problems can be solved at the service center.

It is also necessary to provide product firmware 320 and product support software 315 along with hardware processes. The product firmware is internal software that satisfies the CDMA modem protocol, and the product support software is a software tool used to check and maintain the performance of hardware. This includes hardware tests, control, RF calibration, firmware downloading for each production process. In other words, the product firmware is internal software which provides CDMA data modem function to the end user. The product support software is used for the production process and in service centers. The product support software is largely divided into an application program executable in PCs and the support firmware that operates in the CDMA products. The support firmware is unrelated to the CDMA modem protocol and operates independently.

FIG. 2 illustrates a detailed procedure of mass production process 310 illustrated in FIG. 1. The mass production is divided into MTC (Manufacturing Technique Control) 400 and QC (Quality Control) 405. In MTC, the product line is prepared and designed 410, a visual test on assembled hardware is performed and a POST (Power-On Self Test) 420 implemented. At the POST, there is a check to see if the hardware operates normally as soon as the hardware receives the power and boots up the internal software and the product firmware. If the POST fails, the manufacturer finds and solves the problems and begins the repair process. If there are errors in the design, adjustments are applied to the product and the process is re-started from the beginning. If the product successfully passes the POST, the procedure moves on to the next stage, which is the QC 405.

The first stage of the QC 405 is the RF calibration and test 435. For example, the RF calibration is a procedure to extract the RF circuit control parameters necessary for protocol or for the CDMA modem signal to perform normally. This procedure is generally automated. If RF calibration fails the first time, a check is performed to see if repair is possible. If not, the problems are recorded and analyzed 445 and applied to the design. Generally, even if RF circuits have an identical design, little differences exist after assembly. Therefore, it is ideal to apply RF calibration to all products.

However, this is not realistic in terms of mass production. Therefore, parameters from RF calibration are saved to a database and the statistic value is searched continuously. Subsequently, if the RF parameter value of the product is within the permitted error range, then the statistic value is applied to the products instead of being measured directly. A statistic value is applied to the products and measured through sampling rather than performing RF calibration to all products. If the statistic value remains unchanged from the sampling, the number of samples are decreased. If the statistic value falls out of the permitted error range, RF calibration is performed on all products.

RF parameter are obtained from the products and statistic value are continuously updated. For products that have completed the RF calibration, the latest update of the product firmware is downloaded in the internal memory and the adjusted NV (Non-Volatile) database and PRL (Preferred Roaming List) data 450 are initialized to the corresponding service provider. PRL data is a system lookup table, necessary for the products to connect to the base station within the coverage area of service provider. The CDMA modem protocol makes a connection to the system according to the PRL list. An operation method for a PRL list is regulated by an international standard, TIA/EIA/IS-683A.

The NV data is a database that regulates the internally used parameter of the CDMA modem protocol to connect to a base station. For example, the NV database includes operational parameters that are required to initialize RF circuit hardware and internal software variables. When the modem is powered on, the microprocessor loads the NV data from the NV memory (a non-volatile memory) and initializes RF circuit and software variables. Because the contents of NV data and PRL data must be saved even if the CDMA product power goes off, they are usually saved in EEPROM or flash ROM.

After the product firmware has been downloaded, the product is manually operated to check performance and assembled as a final product 455. The final stage for the mass production is ESN write 460. The ESN (Electronic Serial Number) is a unique identification number, so it cannot be duplicated until the final assembled product is terminated. ESN is saved in the NV data area, and it can be access to read, but it cannot be re-written once they are done. The manufacturer saves and manages the ESN in a database 465. The manufacturer should save a product's ESN, RF calibration data, NV data, PRL data in a corresponding maintenance and management database. The data should be used for maintenance and field service.

The operation of the conventional modem is described in reference to FIGS. 3A to 6B. When the power source is applied to the microprocessor and the reset signal is generated to the ARM core, it reads machine code from the ROM of flash memory and starts the boot up process. FIG. 3A shows the variation in the address map of the flash memory during the microprocessor boot up. The mapping of code and data before boot up of product firmware is shown in the left side of FIG. 3A. The flash memory is divided into a ROM area 500 and a RAM area 505. The firmware code and the program variable exist in the ROM area prior to the boot up. When the microprocessor boots up, it initializes the basic necessary hardware, such as memory, control circuits, clock, etc. It also copies RW-DATA 525 and ZI-DATA 520 that are in the ROM area 500 of the flash memory to the RAM area 505. The ZI-DATA 520 has program variables of all zeros when the firmware first initializes. The RW-DATA 525 has predetermined program variables when the firmware first initializes. After the completion of the microprocessor boot up, the firmware code 530 begins operation using the variables stored in the RAM area 505.

FIG. 3B illustrates the use of a boot loader (one of the product support software) which is used to update existing product firmware to a new version. The boot loader resides in a firmware module in the ROM area of the flash memory. It has the capability to download an application module to a specific RAM of the flash memory by communicating with product support software in PC. The boot up loader completes a normal firmware operation after downloading an application module and executes the downloaded application module 560. Because an application module down loaded using the boot loader is executed in the RAM area 505 of the flash memory, it is possible to adjust the firmware in ROM area of the flash memory as soon as the microprocessor boots up. However, such an application module over writes the firmware and program variable residing in the RAM area of the flash memory. Therefore, it is impossible to operate the firmware normally unless the power is turned off and back on. As a result, the boot loader is only used for the purpose of product support.

FIGS. 4A and 4B show the product firmware mapping in the ROM area of the flash memory. Conventionally, the product firmware is divided functionally into a boot block 600 and an application block 605. The roles of the firmware module in the boot block 600 are: hardware initialization, memory test and memory initialization, such as ZI-DATA and RW-DATA. The CDMA firmware module 615 in the application block 605 is necessary for the normal operation of the CDMA modem protocol. Error exception cases resulting from the operation of product firmware are handled by an error exception handler 620 provided in the microprocessor.

The error exception handler 620 is located in the boot block 600. A boot block 600 and an application block 605 that are functionally divided can be divided physically in different areas of the flash memory as shown in FIG. 4A. For example, the boot block 600 can be located in 0x0˜0x3FFF of ROM area of the flash memory and the application block 605 can be located in after number 0x4000.

In this case, if the volume of the boot block 600 is less than 0x4000, there will be no value in between the ending address of the boot block 600 and the start address (0x4000) of the application block 605. Such address mapping is illustrated in FIG. 4B.

As shown in FIG. 4A, when the boot block 600 and the application block 605 are separated, it is possible to update only the application block 605 with the boot block 600 unchanged. Because the boot loader 550 is included in the boot block 600, even if the firmware malfunctions in the application block 605, the boot loader 550 can rewrite the application module 560 in the ROM area of the flash memory. Once the application module is updated by the boot loader, then the hardware should be rebooted so that the new application module becomes effective.

The microprocessor of the modem uses the error handler 620 to support many errors. They are shown in the Table 1 below.

TABLE 1
Error exception vector Table of ARM7TDMI core processor.

| | Vector |
|---|---|
| Exception | Address |
| Reset | 0x00000000 |
| Undefined instruction | 0x00000004 |
| Software interrupt (SWI) | 0x00000008 |
| Prefetch abort (instruction fetch memory fault) | 0x0000000C |
| Data abort (data access memory fault) | 0x00000010 |
| Address exceptions (unused with 32-bit ARM) | 0x00000014 |
| IRQ (normal interrupt) | 0x00000018 |
| FIQ (fast interrupt) | 0x0000001C |

A reset handler is a firmware module that performs boot up as soon as the reset signal generates to the microprocessor. The undefined instruction handler runs when the opcode fetch by the ARM CPU is invalid. The software interrupt handler runs when the software interrupt generates during the firmware. The prefech abort and data abort error runs when an error occurs during the reading of data from the memory. The IRQ and FIQ handler runs when the IRQ interrupt and the FIQ interrupt signal are generated, respectively. The vector addresses of the error handler 620 in Table 1 are in between 0x0 and 0x1F in ROM area of the flash memory.

When the boot block 600 and the application block 605 are separated as shown in FIG. 4A, the error handler 620 resides in the boot block 605. That is, the main function of the firmware code of the application block 605 is to manage CDMA modem protocol and the function of the error handler 620 is only to support. Therefore, it is necessary to locate them in different memory maps so as not to interfere with each other.

Production of the CDMA data modem involves working on the prototype production to the mass production, and the product firmware that takes care of the CDMA modem protocol necessary to operate hardware. The product support tool for hardware development and production is different and separate from the support tool used for post-product delivery, field service and maintenance. It applies the separate structure of a boot block and an application block for product firmware. The invention embodies a procedure that provides an efficient and consistent product support tool, that defines and differentiates the firmware module for product support, locates them in the boot block, and to activate/deactivate as hardware.

### SUMMARY OF THE INVENTION

Accordingly, the present invention is directed to a data modem that substantially obviates one or more of the problems due to limitations and disadvantages of the related art.

It is an object of the present invention to provide easy testing of the modem for enhanced field service and maintenance.

It is another object of the present invention to provide a modem with easy testing characteristic so that it is easy to develop and manufacture.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a mobile telecommunication apparatus, such as a CDMA modem for use with a host computer comprises a microprocessor; an interface device communicating with the microprocessor to interface with the host computer; a memory connected to the microprocessor having a ROM area and a RAM area, the ROM area storing a modem protocol code for operation of the modem and a testing code for testing the modem; an antenna; a RF/IF device connected to the antenna and communicating with the microprocessor; and a code selection switch connected to the microprocessor to select one of a normal mode and a service mode, wherein upon selection of the normal mode, the modem protocol code is executed, and upon selection of the service mode, the testing code is executed.

According to one aspect of the present invention, the code selection switch is connected to a general purpose input and output port of the microprocessor. Preferably, the ROM area of the memory is divided into a boot block and an application block, wherein the application block stores the modem protocol code for normal operation of the modem. The testing code is a test control and calibration (TCC) loader stored in the boot block of the memory.

According to another aspect of the present invention, upon selection of the service mode, the TCC loader is copied from the ROM area to the RAM area for execution by the microprocessor. The TCC loader tests the integrity of hardware used in the modem.

According to the present invention, a CDMA modem comprises all of the above components and a programmable read only memory (PROM) connected to the microprocessor, in lieu of the code selection switch. The PROM contains modem parameters and configuration data that includes a boot mode register to select at least one of a normal mode and a service mode. Upon selection of the normal mode, the modem protocol code is executed, and upon selection of the service mode, the testing code is executed.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 is a general time line of the CDMA product development and manufacturing process;

FIG. 2 is a detailed flow chart of mass production process;

FIG. 3A is a mapping of the flash memory during a boot up procedure;

FIG. 3B illustrates a downloading of the application module by a boot loader in the boot block;

FIG. 4A is a memory map illustrating the separate location of the boot block and the application block;

FIG. 4B is a memory map of the product firmware without fixed starting address of the application block;

FIG. 5 is a PCMCIA CDMA data modem with code selection switch on the front side;

FIG. 6 is a schematic block diagram of PCMCIA CDMA data modem according to a preferred embodiment of the present invention;

FIG. 7A illustrates a memory map the product firmware including the TCC loader during the boot up process

FIG. 7B is a memory map of the product firmware when the modem boots up in service mode;

FIG. 8A is a boot-up procedure of the product firmware which contains the TCC loader in it;

FIG. 8B is a flow chart for checking the status of the code selection switch;

FIG. 8C is a flow chart for checking the validity of the firmware residing in the application block;

FIG. 9A illustrates a memory map and flow chart of the boot block, containing the TCC loader, and the application block, wherein the boot jumper is residing in the application block;

FIG. 9B illustrates a memory map and flow chart of the boot block, containing the TCC loader, and the application block, wherein the application block is abnormally loaded or empty; and

FIG. 10 is a hardware initialization flow chart of the boot up procedure.

### DETAILED DESCRIPTION OF THE PREFERRED EMBODIMENTS

Hereinafter, the present invention will be described with respect to the preferred embodiment illustrated in the annexed drawings.

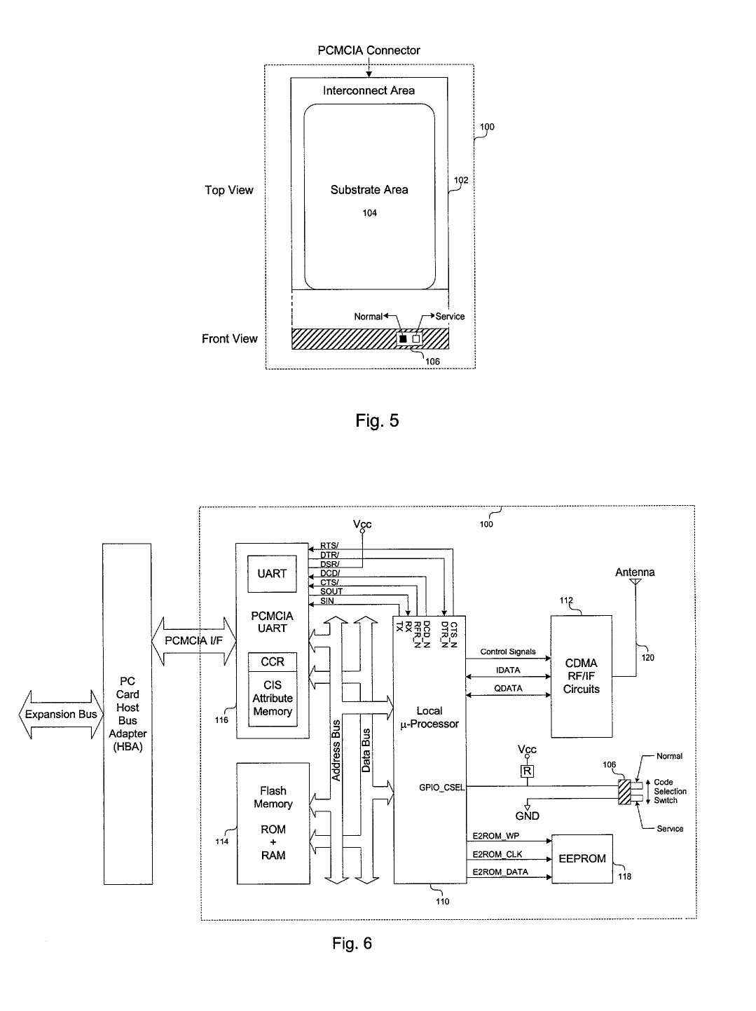

FIG. 5 shows external views of the PCMCIA CDMA data modem 100 according to the preferred embodiment of the present invention. An interconnect area of the modem 100 represents the area occupied by a PCMCIA connector 102 and the substrate area 104 is the remaining area for hardware installation. According to the preferred embodiment of the present invention, there is a code selection switch 106 located in the end of the modem 100. When the modem 100 is inserted to a PCMCIA slot of a notebook PC, the code selection switch is exposed to the user. When the card is inserted into a PCMCIA slot with the code selection switch 106 set to a normal mode, the CDMA modem protocol performs a normal operation by executing the code residing in the application block 605 after the boot up.

FIG. 6 illustrates a schematic block diagram of PCMCIA CDMA data modem according to the preferred embodiment of the present invention. The modem 100 includes a microprocessor 110, such as MSM3100 of Qualcomm, and a CDMA RF/IF circuit 112 connected to an antenna 120. The microprocessor 110 preferably includes an ARM7 core, a digital signal processor core, and other I/O device controller. In addition, the modem 100 further includes flash memory 114, EEPROM 118, and PCMCIA interface device 116, such as TL16PC564A manufactured by Texas Instruments. The CDMA RF/IF circuit 112 and the antenna 120 provide the CDMA wireless link to the microprocessor 110.

Preferably, the flash memory 114 has product firmware, re-programmable ROM for initialization data and RAM to save temporary data during the run time. The firmware and initialization data in ROM cannot be deleted even the power is off, but data in RAM can be deleted as soon as the power is shut off. The product firmware used by the microprocessor 110 is in the ROM area of the flash memory and the variable and parameter used during run-time are in the RAM area of the flash memory. The flash memory and the interface device 116 are accessed through an address bus and a data bus of the microprocessor 110 and starts to read and write.

The parameters, such as NV data and PRL data, are re-programmable and saved in EEPPROM. The EEPROM is a rewritable memory device, and it has a capability of a database to save a CDMA parameter for the CDMA modem protocol and the content will remain even if the power is turned off. Access to the EEPROM is not gained through an address bus and a data bus of the microprocessor 110, but it operates to read/write through the three control pins.

Because the PCMCI interface device 116 has an UART module inside, it interfaces with the UART module of the microprocessor 110 according to RS232 standard and the HBA (Host Bus Adapter) of PC interfaces according to the PCMCIA standard. In addition, the interface device 116 has a 256 byte long DPRAM, which is used to save the CIS tuple data. The CIS tuple data defines the hardware information to be registered in the PCMCIA modem 100 as a PC peripheral. As soon as the PCMCIA modem 100 is inserted to the slot, it automatically fetches to the PC and starts the initializing configuration. The data communication becomes possible between PC host and PCMCIA modem 100 after initializing the interface of the modem with the CIS tuple data.

According to the preferred embodiment of the present invention, the modem 100 has a code selection switch 106 which activates or deactivates the product support firmware. When the normal mode is selected, a normal operation of CDMA modem protocol is executed as soon as CDMA modem boots up. When the service mode is selected, a product support module in the boot block is executed rather than performing a normal CDMA modem protocol.

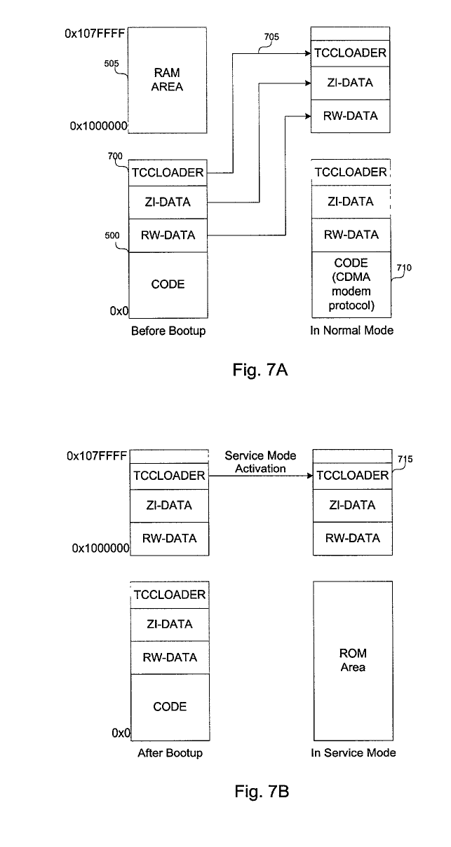

FIG. 7A illustrates a memory map of the product firmware including the TCC loader 700 during the boot up process. When the service mode is selected for the code selection switch 106, the modem card 100 runs the TCC (Test, Control and Calibration) loader 700 in the boot block 600 instead of performing a normal CDMA modem protocol. The TCC loader 700 is a firmware module unrelated to CDMA modem protocol, and supports device operations, such as hardware test, RF calibration, firmware downloading and NV data update. The TCC loader 700 is a software module designed to support production manufacturing, including working prototype production, mass production, product delivery, support maintenance and field service.

The microprocessor generates a reset handler as soon as power turns ON and begins the boot up procedure. The microprocessor copies variables or parameters for the production firmware from the ROM area 500 of the flash memory to the RAM area 505 after hardware initialization. The TCC loader 700 is copied to the RAM area 505 at this stage. That is, the TCC loader 700 operates not in the ROM area of the flash memory, but resides in the RAM area 505.

After the completion of above procedure, the CDMA modem protocol 710 performs normal operations if the code selection switch 106 of the modem is in the normal mode. Referring to FIG. 7B, if the code selection switch 106 is in the service mode, the modem protocol is inhibited. The TCC loader 700 then has access to various hardware of the modem 100, such as flash memory, interface chip, EEPROM, and RF/IF circuit.

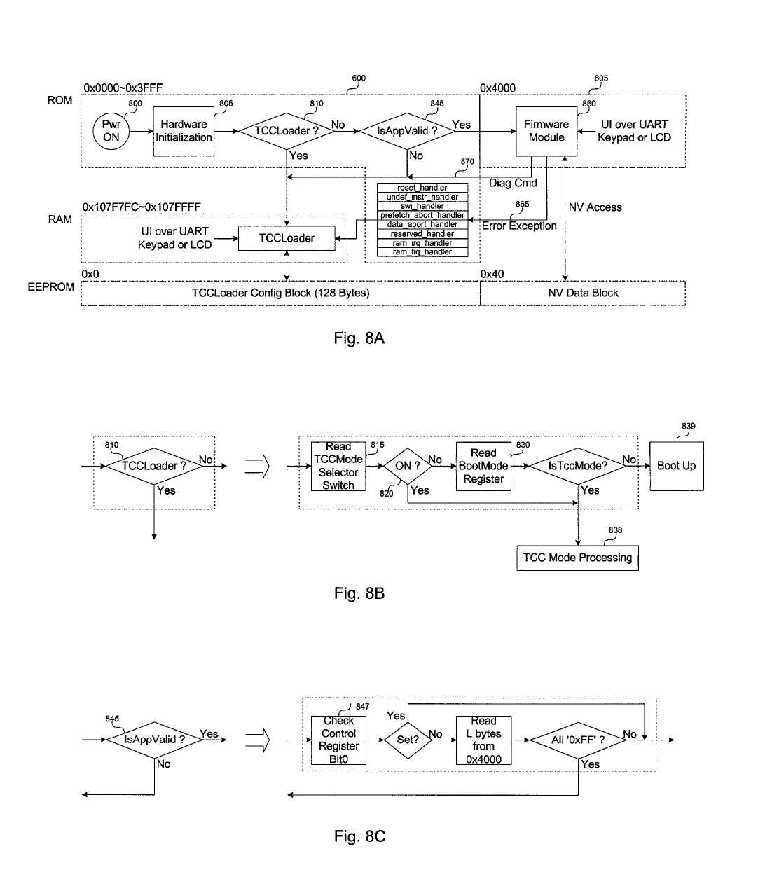

FIG. 8A illustrates the boot up procedure of the product firmware that contains the TCC loader 700. In particular, the microprocessor begins the reset handler when the power is applied 800 and begins the boot up procedure. The first stage of the procedure is to initialize the hardware 805, such as memory access control register, clock generation register, peripheral device control register of MSM 3100, and to inspect memory operation by the RAM read/write test.

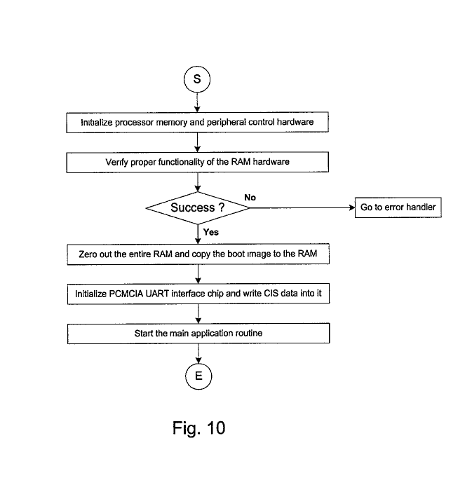

When these procedures are successfully completed, the microprocessor copies the ZI-DATA, the RW-DATA and the TCC loader to the RAM area 505 of the flash memory. Finally, the microprocessor sets control registers of the PCMCIA interface chip, for example, TL16PC564A manufactured by Texas Instrument. The hardware initialization completes by initializing the attribute memory with the CIS tuple data. The flow chart of the hardware initialization is shown in FIG. 10.

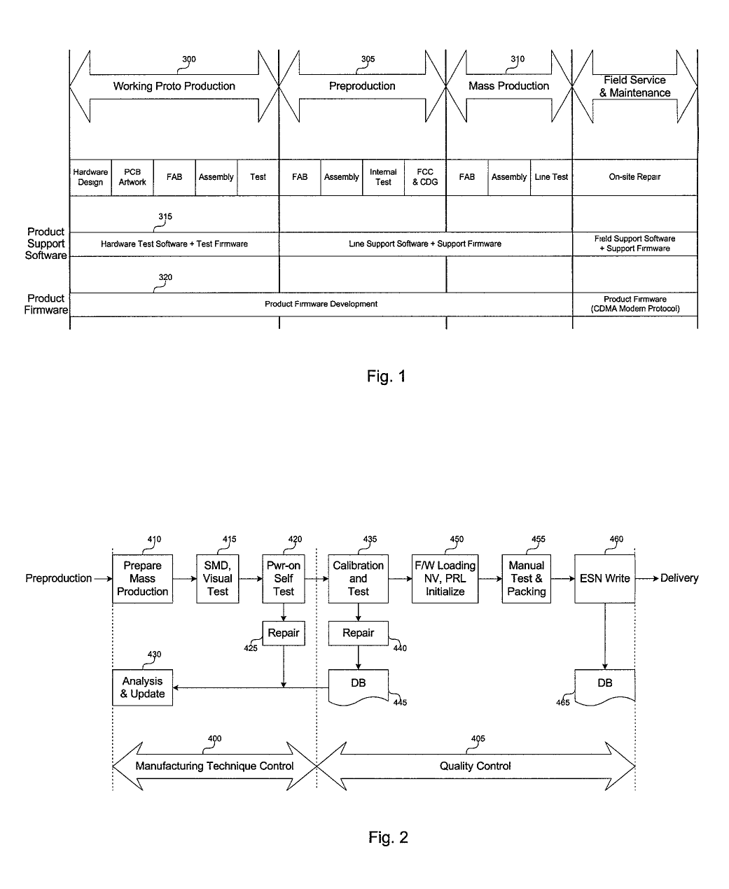

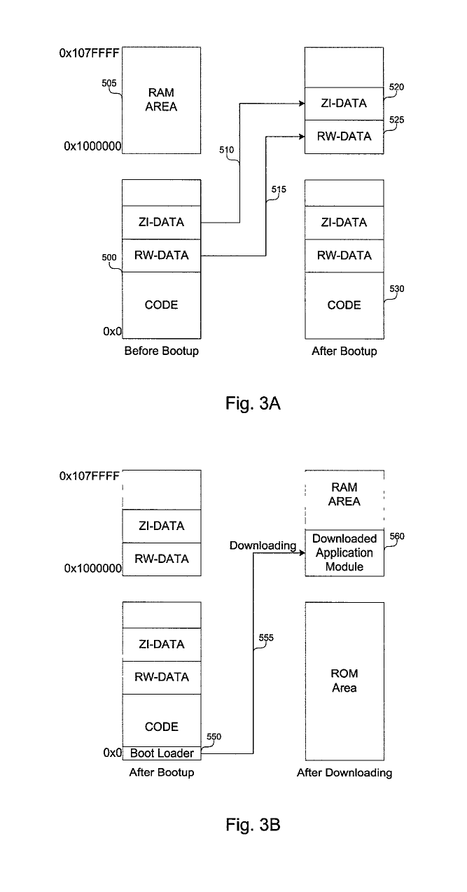

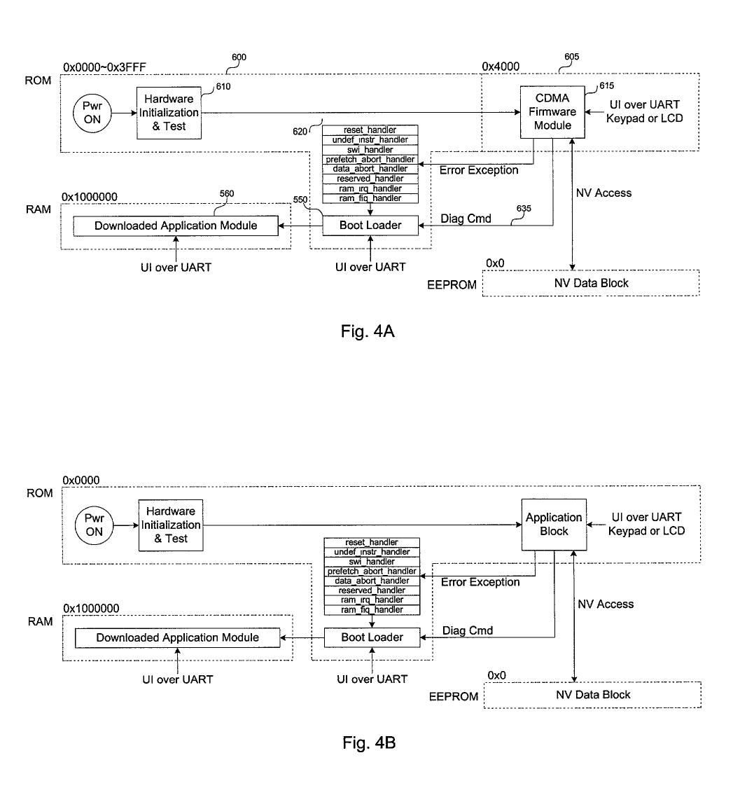

FIG. 8B is a flow chart for checking the status of the code selection switch. After the boot up procedure, the modem 100 determines whether to activate the TCC loader by examining the code selection switch. According to FIG. 8B, a check is made to see if the modem is in a normal mode or a service mode 815, 820 by reading the status of the code selection switch 106. Preferably, the code selection switch 106, shown in FIGS. 1 and 2, is connected to one of the GPIO (General Purpose Input and Output) ports of the microprocessor. For example, the code selection switch 106 represents a normal mode if the voltage at the GPIO port is high (OFF) and represents a service mode if it is low (ON). Namely, it jumps to the TCC loader processing 838 if the code selection switch 106 is set to the service mode (ON). Otherwise, the boot mode register is examined 830.

Preferably, the microprocessor checks the boot mode register (1 byte, address=0x00) that is defined in the TCC loader configuration block of the EEPROM. If the test result for the boot mode register is FALSE 835, the boot up procedure is continued. If the boot mode register is set to TRUE, the the TCC mode processing is initiated 838.

The additional purpose of boot mode register is to provide the code selection mechanism even when the incorporation of switch into the modem is difficult. Preferably, under normal operation condition, the boot mode register will be set not to invoke the code selection mechanism.

FIG. 8C is a flow chart for checking the validity of the firmware residing in the application block 605. If the code selection switch 106 is set to a normal status, the modem checks the validity of the application block in step 845 before executing the CDMA modem protocol. If the product firmware does not exist in the application block 605, normal operation is not possible and thus jumps to the TCC loader process shown in FIG. 8B.

There are many ways to check the validity of the application block. The following description provides one of such ways as an example. For example, the modem 100 according to the preferred embodiment checks the application block validity by reading the L bytes, L being an integer, from address 0x4000 (where the application block begins). If the read values of the L bytes are not 0XFF, it is deemed that the application block is valid. Conversely, if the values are not 0xFF, then the application block is invalid. This is because the 0xFF is default value of the flash memory when such memory is erased. The present invention uses such characteristics of the flash memory to examine the validity of the application block.

According to FIG. 8C, before examining the contents of the flash memory, the determination of whether to perform the validity check of the application block is performed by examining the control register 847 defined in the TCC loader configuration block of the EEPROM. For example, when bit 0 of the control register is set (logical 1) the validity check for the application block is skipped.

After boot up procedure is completed without selecting the TCC loader, the firmware module 860 (e.g., CDMA modem protocol) begins execution in the application block 605, as shown in FIG. 8A. This constitutes a normal operation of the modem.

There are three different ways to execute the TCC loader during the normal operation of the modem. First method is an abnormal situation where the microprocessor of the modem detects an error 865 and the control is passes to the TCC loader through an error handler. The second method, shown as path 870 in FIG. 8A, is to call the TCC loader with product support software executed in a PC host. This step can occur while executing the normal modem protocol.

Third method comprises enabling the boot mode register of the TCC loader configuration block residing in the EEPROM during normal operation of the modem. As a result, during boot up (by turning the power off and on), the TCC loader is executed.

No matter how the TCC loader is initiated, the TCC loader is a separate firmware not related to the CDMA modem protocol. The TCC loader is a product support firmware module used for testing modem hardware, RF calibration, control, firmware downloading and NV data update. The code selection switch in conjunction with the boot mode register of the modem according to the preferred embodiment provides such testing options.

While the EEPROM is originally used to store modem parameter and NV data for the CDMA modem protocol, it can also be used to store configuration data to control the TCC loader operation. The TCC configuration block in the EEPROM is preferably 128 bytes in length and is shown in Table 2.

TABLE 2
Data structure of TCC loader configuration block in the EEPROM.

| | Length | |
|---|---|---|
| Start Address | (Byte) | Description |
| 0x00 | 1 | Boot Mode Register |
| 0x01 | 1 | Control Register |
| 0x02 | 2 | Status Register (unsigned 2bytes, 0x2: MSB, |
| | | 0x3:LSB) |
| 0x04 | 4 | Boot Block Version ASCII String (“N.MN”, |
| | | N:boot block, MM: TCBooter) |
| 0x08 | 1 | L, number of bytes to read for application |
| | | block validity check |
| 0x09x˜0x03F | — | Reserved |

The boot mode register is 8 bits. The value of the boot mode register determines whether to call the TCC loader. The definition of the boot mode register value and the description of IsTccMode are shown in Table 3.

TABLE 3
Boot mode register of TCC loader configuration block.

| Value | IsTccMode | Description (b4:TCCBooter enable flag) |
|---|---|---|
| 0x00 | TRUE | Unconditional branch to TCC loader (include |
| | | EEPROM read error case) |
| 0x01 | Don't care | Empty application block |
| 0x02 | FALSE | Bootjumper in the application block |
| 0x03 | FALSE | Normal application block and register check |
| | | disabled |
| 0x13 | TRUE | Normal application block and register check |
| | | enabled |
| Others | FALSE | Not defined |

A single bit of the control register is used for the operation control, either a path selection or a boot up procedure. The definitions of each bit are shown in Table 4.

TABLE 4
Control register of TCC loader configuration block.

| Bit # | Description |
|---|---|
| 0 (LSB) | Skip application validity check. If clear, check IsAppValid. |
| | Otherwise, skip IsAppValid. |
| Other | Reserved |

The status register is used to store error exception cases as defined by the microprocessor as shown in Table 5.

TABLE 5
Status register of TCC loader configuration block

| Bit # | Description |
|---|---|
| 0 (LSB) | If set, then it means undefined instruction error exception |
| | occurred. |
| 1 | If set, then it means software interrupt occurred. |
| 2 | Is set, then it means prefetch abort exception occurred. |
| 3 | If set, then it means data abort exception occurred. |
| 4 | Not defined. |
| 5 | If set, then it means RAM IRQ occurred. |
| 6 | If set, then it means RAM IRQ occurred |
| Others | Reserved |

The boot block version string is ASCII string that contains the boot block version and the TCC loader version which contains the TCC loader. The boot block version has the format of “N.MM”. “N” indicates the boot block version and the value is 0 to F. “MM” indicates the TCC loader version and “M” has the value of 0 to F.

L register shows the address range when checking the validity of the application block and can have a maximum of 256 bytes.

The operations of product support software of PC host that can be used simultaneously with the TCC loader are shown in Table 6.

TABLE 6
TCC loader operation list

| No | Feature Category | Description |
|---|---|---|
| 1 | F/W Handling | Download or unload of an application firmware |
| | | or the boot block |
| 2 | EEPROM Access | EEPROM access to read and write. (NV data |
| | | and TCC configuration block) |
| 3 | RF Control | RF Tx and Rx hardware control |
| 4 | RF Calibration | RF control to find calibration data |
| 5 | Register Handling | MSM3100 internal register access to read |
| | | and write (exclude GPIO) |
| 6 | UART Control | TL16PC564A interface chip control |
| 7 | GPIO Port Control | GPIO port control |
| 8 | Peripheral Control | Audio, USB, Keypad, LCD display, etc. |

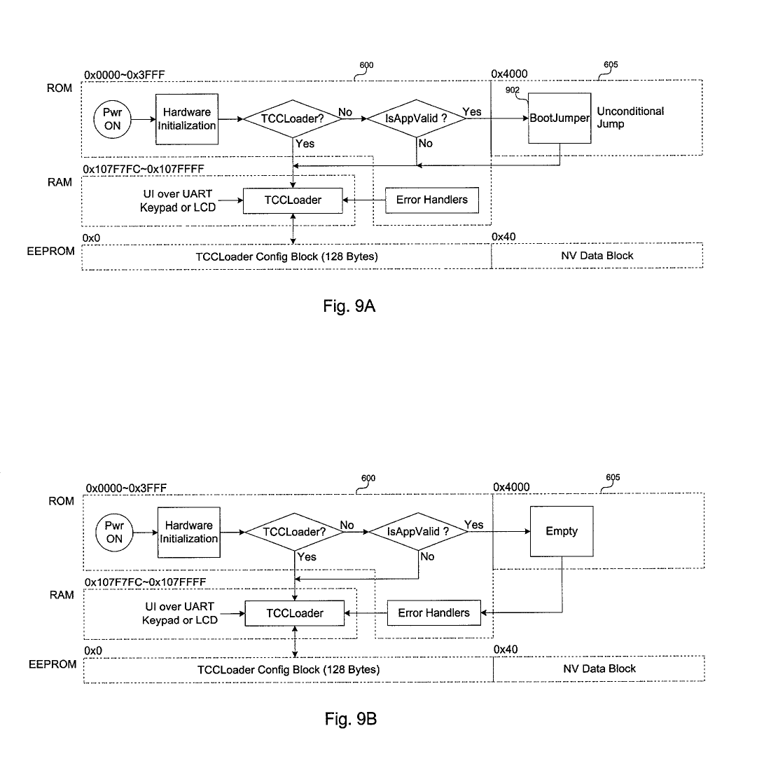

FIGS. 9A and 9B show the operation of the TCC loader without the normal application block. In particular, FIG. 9A illustrates a memory map and flow chart of the boot block, containing the TCC loader, and the application block, wherein the boot jumper 902 is residing in the application block. FIG. 9B illustrates a memory map and flow chart of the boot block, containing the TCC loader, and the application block, wherein the application block is abnormally loaded or empty.

The modem according to the present invention uses the code selection switch to efficiently and simply support manufacturing process, maintenance, and field service after the product delivery. The code selection switch also operates in conjunction with the TCC loader which is in the TCC loader configuration block preferably residing in the EEPROM.

Although the present invention is described with respect to the CDMA data modem, but may also be used on products using CDMA modem protocol, such as cellular phone. By storing the TCC loader in the boot block independently from the product firmware that manages CDMA modem protocol, it can provide a simple access to support production, maintenance and repair.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A CDMA modem for use with a host computer, the modem comprising:
a microprocessor;
an interface device communicating with the microprocessor to interface with the host computer;
a memory connected to the microprocessor having a ROM area and a RAM area, the ROM area storing a modem protocol code for operation of the modem and a testing code for testing the modem;
an antenna;
a RF/IF device connected to the antenna and communicating with the microprocessor; and
a code selection switch connected to the microprocessor to select one of a normal mode and a service mode, wherein upon selection of the normal mode, the modem protocol code is executed, and upon selection of the service mode, the testing code is executed.

2. The CDMA modem of claim 1, wherein the code selection switch is connected to a general purpose input and output port of the microprocessor.

3. The CDMA modem of claim 1, wherein the ROM area of the memory is divided into a boot block and an application block, wherein the application block stores the modem protocol code for normal operation of the modem.

4. The CDMA modem of claim 3, wherein the testing code is a test control and calibration (TCC) loader stored in the boot block of the memory.

5. The CDMA modem of claim 4, wherein upon selection of the service mode, the TCC loader is copied from the ROM area to the RAM area for execution by the microprocessor.

6. The CDMA modem of claim 4, wherein the TCC loader tests the integrity of hardware used in the modem.

7. The CDMA modem of claim 2, wherein the ROM area of the memory is divided into a boot block and an application block, wherein the application block stores the modem protocol code for normal operation of the modem.

8. The CDMA modem of claim 7, wherein the testing code is a test control and calibration (TCC) loader stored in the boot block of the memory.

9. The CDMA modem of claim 8, wherein upon selection of the service mode, the TCC loader is copied from the ROM area to the RAM area for execution by the microprocessor.

10. A CDMA modem comprising:
a microprocessor;
an interface device communicating with the microprocessor to interface with the host computer;
a memory connected to the microprocessor having a ROM area and a RAM area, the ROM area storing a modem protocol code for operation of the modem and a testing code for testing the modem;
an antenna;
a RF/IF device connected to the antenna and communicating with the microprocessor; and
a programmable read only memory (PROM) connected to the microprocessor, the PROM containing modem parameters and configuration data that includes a boot mode register to select at least one of a normal mode and a service mode, wherein upon selection of the normal mode, the modem protocol code is executed, and upon selection of the service mode, the testing code is executed.

11. The CDMA modem of claim 10, wherein the ROM area of the memory is divided into a boot block and an application block, wherein the application block stores the modem protocol code for normal operation of the modem.

12. The CDMA modem of claim 11, wherein the testing code is a test control and calibration (TCC) loader stored in the boot block of the memory.

13. The CDMA modem of claim 12, wherein upon selection of the service mode, the TCC loader is copied from the ROM area to the RAM area for execution by the microprocessor.

14. A mobile communication device comprising:
a microprocessor;
an interface device communicating with the microprocessor to interface with the host computer;
a memory connected to the microprocessor having a ROM area and a RAM area, the ROM area storing a modem protocol code for operation of the modem and a testing code for testing the modem; and
a code selection switch connected to the microprocessor to select one of a normal mode and a service mode, wherein upon selection of the normal mode, the modem protocol code is executed, and upon selection of the service mode, the testing code is executed.

15. The mobile communication device of claim 14, wherein the code selection switch is connected to a general purpose input and output port of the microprocessor.

16. The mobile communication device of claim 14, wherein the ROM area of the memory is divided into a boot block and an application block, wherein the application block stores the modem protocol code for normal operation of the modem.

17. The mobile communication device of claim 16, wherein the testing code is a test control and calibration (TCC) loader stored in the boot block of the memory.

18. The mobile communication device of claim 17, wherein upon selection of the service mode, the TCC loader is copied from the ROM area to the RAM area for execution by the microprocessor.

19. A method of testing a CDMA modem for use with a host computer, the CDMA modem comprising a microprocessor; an interface device communicating with the microprocessor to interface with the host computer; a memory connected to the microprocessor having a ROM area and a RAM area, the ROM area storing a modem protocol code for operation of the modem and a testing code for testing the modem; an antenna; a RF/IF device connected to the antenna and communicating with the microprocessor; and a programmable read only memory (PROM) connected to the microprocessor, the PROM containing modem parameters and configuration data that includes a boot mode register to select at least one of a normal mode and a service mode, the method comprising the steps of:
detecting an error in hardware using the microprocessor, wherein the microprocessor executes an error handler that loads the testing code into the RAM area for execution by the microprocessor.

20. The method of claim 19, further comprising setting the boot mode register to a predetermined value to enable the loading of the testing code into the RAM area and execution of the testing code during a next boot up.

21. The method of claim 19, further comprising the hosting computer loading the testing code into the RAM area of the modem and causing the execution of the testing code during normal operation the modem protocol code.
